(19) United States
(12) Patent Application Publication
(10) Pub. No.: US 2023/0237616 A1
(43) Pub. Date: Jul. 27, 2023

(54) IMAGE PROCESSING SYSTEM AND METHOD FOR GENERATING A SUPER-RESOLUTION IMAGE

(71) Applicant: SONIC STAR GLOBAL LIMITED, Road Town (VG)

(72) Inventor: CHIH-WEI CHIANG, TAOYUAN CITY (TW)

(21) Appl. No.: 17/586,568

(22) Filed: Jan. 27, 2022

(51) Int. Cl. G06T 3/40; G06T 7/50; G06T 1/20; G06T 15/20

(52) U.S. Cl. CPC G06T 3/4053; G06T 7/50; G06T 1/20; G06T 15/205; G06T 2207/10024; G06T 2207/20084

(57) ABSTRACT

The present application discloses an image processing system. The image processing system comprises a first processing unit and a memory. The first processing unit receives a three-dimensional scene comprising a plurality of objects, generates a depth map according to distances between the objects and a viewpoint, renders a normal-resolution image of the scene observed from the viewpoint according to the depth map, appends depth information to the normal-resolution image to generate a normal-resolution image layer, and outputs the normal-resolution image layer. The normal-resolution image layer comprises three color channels and one alpha channel, in which color values of each of pixels of the normal-resolution image are stored in the three color channels of the normal-resolution image layer, and first depth values of the pixels of the normal-resolution image are stored in the alpha channel of the normal-resolution image layer. The memory stores the normal-resolution image layer.

### TECHNICAL FIELD

The present disclosure relates to an image processing system, and more particularly, to an image processing system for generating super-resolution images.

### DISCUSSION OF THE BACKGROUND

As consumers have higher and higher expectations for visual effects delivered by electronic devices, electronic devices often need to support various image processing operations, such as 3D scene drawing, super-resolution images, high dynamic range (HDR) images, and so on. To increase speeds of image processing, electronic products are often equipped with a graphics processing unit (GPU) or other types of image processors. When using a GPU to perform specific types of image processing, such as generating super-resolution images, since the GPU can obtain more graphics information, such as depth information, it is able to output super-resolution images of higher qualities. However, since the output image of the GPU can be rather large, the GPU may need to occupy a significant amount of a memory for a long time so as to store the image in the memory, resulting in poor hardware efficiency of an image-processing system. Therefore, finding a means to perform image processing more efficiently while maintaining acceptable image quality has become an issue to be solved.

### SUMMARY

One embodiment of the present disclosure discloses an image processing system. The image processing system comprises a first processing unit and a memory. The first processing unit is configured to: receive a three-dimensional scene comprising a plurality of objects, generate a depth map according to distances between the objects and a viewpoint, render a normal-resolution image of the scene observed from the viewpoint according to the depth map, append depth information to the normal-resolution image to generate a normal-resolution image layer, and output the normal-resolution image layer. The normal-resolution image layer comprises three color channels and one alpha channel, in which color values of each of a plurality of pixels of the normal-resolution image are stored in the three color channels of the normal-resolution image layer, and first depth values of the pixels of the normal-resolution image are stored in the alpha channel of the normal-resolution image layer. The memory is configured to store the normal-resolution image layer.

Another embodiment of the present disclosure discloses an image processing system. The image processing system comprises a first processing unit and a second processing unit. The first processing unit is configured to: receive a three-dimensional scene comprising a plurality of objects, generate depth information of the objects in the three-dimensional scene from a viewpoint, render a normal-resolution image of the scene observed from the viewpoint according to the depth information, append the depth information to the normal-resolution image to generate a normal-resolution image layer, and output the normal-resolution image layer. The normal-resolution image layer comprises three color channels and one alpha channel, in which color values of each of a plurality of pixels of the normal-resolution image are stored in the three color channels of the normal-resolution image layer, and first depth values representing the depth information for each of the pixels of the normal-resolution image are stored in the alpha channel of the normal-resolution image layer. The second processing unit is configured to retrieve the normal-resolution image layer, and to generate a super-resolution image according to at least the color values and the first depth values stored in the normal-resolution image layer,

Another embodiment of the present disclosure discloses a method for generating a super-resolution image. The method comprises receiving, by a first processing unit, a three-dimensional scene comprising a plurality of objects; generating, by the first processing unit, a depth map according to distances between the objects and a viewpoint; rendering, by the first processing unit, a normal-resolution image of the scene observed from the viewpoint according to the depth map; appending, by the first processing unit, depth information to the normal-resolution image to generate a normal-resolution image layer; and outputting, by the first processing unit, the normal-resolution image layer. The normal-resolution image layer comprises three color channels and one alpha channel. Color values of each of a plurality of pixels of the normal-resolution image are stored in the three color channels of the normal-resolution image layer, and first depth values of the plurality of pixels of the normal-resolution image are stored in the alpha channel of the normal-resolution image layer. The method further comprises retrieving, by the second processing unit, the normal-resolution image layer; and generating, by the second processing unit, a super-resolution image according to at least the color values and the first depth values stored in the normal-resolution image layer.

Since the image processing system and the method for generating super-resolution images can use a first processing unit to output a normal-resolution image layer including color and depth information and use a second processing unit to generate a super-resolution image according to both the color and depth information of the normal-resolution image layer, a neuro-network model adopted by the second processing unit can be trained better and the quality of the super-resolution image can be improved. Furthermore, since the depth values are appended to the alpha channel of the image layer, no extra data transfer is required, thereby improving a hardware efficiency of the system.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures.

FIG. 1 shows an image processing system according to one embodiment of the present disclosure.

FIG. 2 shows a flowchart of a method for generating super-resolution images.

FIG. 3 shows a three-dimensional scene according to one embodiment of the present disclosure.

FIG. 4 shows a normal-resolution image layer according to one embodiment of the present disclosure.

FIG. 5 shows a second processing unit in FIG. I that generates a super-resolution image and a super-resolution image layer.

### DETAILED DESCRIPTION

The following description accompanies drawings, which are incorporated in and constitute a part of this specification, and which illustrate embodiments of the is disclosure, but the disclosure is not limited to the embodiments. In addition, the following embodiments can be properly integrated to complete another embodiment.

References to “one embodiment,” “an embodiment” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to unnecessarily limit the present disclosure. Preferred embodiments of the present disclosure will be described below in detail. However, in addition to the detailed description, the present disclosure may also be widely implemented in other embodiments. The scope of the present disclosure is not limited to the detailed. description, and is defined by the claims.

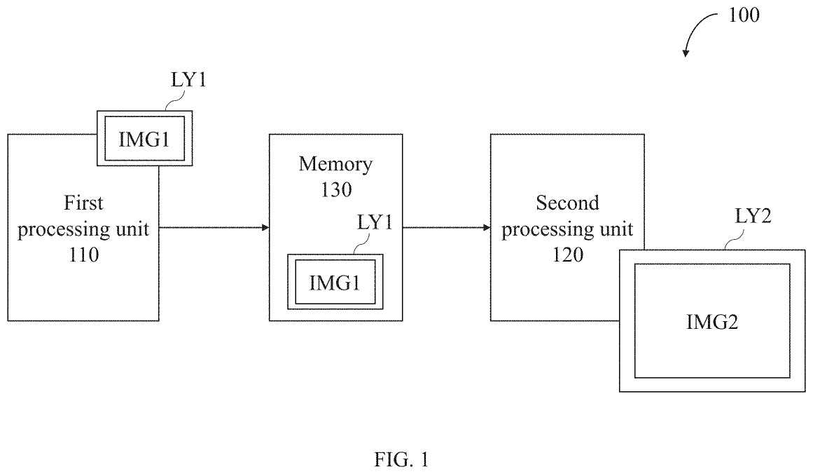

FIG. 1 shows an image processing system 100 according to one embodiment of the present disclosure. The image processing system 100 includes a first processing unit 110 and a second processing unit 120. In the present embodiment, the first processing unit 110 may render an image IMG1 of a three-dimensional scene and append depth information obtained during the rendering process to the image IMG1 to generate an image layer LY1, and the second processing unit 120 may then generate a super-resolution image IMG2 according to color information and depth information stored in the image layer LY1.

Furthermore, in the present embodiment the super-resolution image IMG2 generated by the second image processing unit 120 has a resolution higher than the resolution of the image IMG1 generated by the first image processing unit 110. Therefore, in some embodiments, the image IMG1 generated by the first image processing unit 110 may be referred to as a “normal-resolution image” so as to distinguish the image IMG1 from the super-resolution image IMG2 generated by the second processing unit 120.

Since the second processing unit 120 may generate the super-resolution image IMG2 according to both the color information and the depth information stored in the normal-resolution image layer LY1, the second processing unit 120 is able to generate the super-resolution image IMG2 having high quality. For example, with the depth information, boundaries of objects shown in the image IMG1 can be found easily, so the second processing unit 120 may achieve a better anti-aliasing effect when upscaling the normal-resolution image IMG1 for forming the super-resolution image IMG2. However, the present disclosure is not limited thereto. In some other embodiments, the second processing unit 120 may include a neuro-network model, such as an artificial intelligence deep learning model, and the color information and the depth information stored in the normal-resolution image layer LY1 may be provided as input data for the neuro-network model. In such case, the inputting of different types of information, such as the color information and the depth information, allows the neuro-network model of the second processing unit 120 to be trained and evolve better, thereby improving the quality of resulting super-resolution images.

Furthermore, in some embodiments, the first processing unit 110 may be a graphics processing unit (GPU), and the second processing unit 120 may be a display processing unit (DPU). In such case, after the first processing unit 110 generates the normal-resolution image layer LY1, the first processing unit 110 may store the normal-resolution image layer LY1 in an output buffer, such as a memory 130 of the image processing system 100, and the second processing unit 120 may access the to memory 130 to retrieve the normal-resolution image layer LY1 for generating the super-resolution image IMG2. Since the data size of the normal-resolution image layer LY1 generated by the first processing unit 110 is significantly smaller (compared to the data size of a super-resolution image layer), both the first processing unit 110 and the second processing unit 120 may access the memory 130 without occupying a significant amount of memory, thereby improving a hardware efficiency of the image processing system.

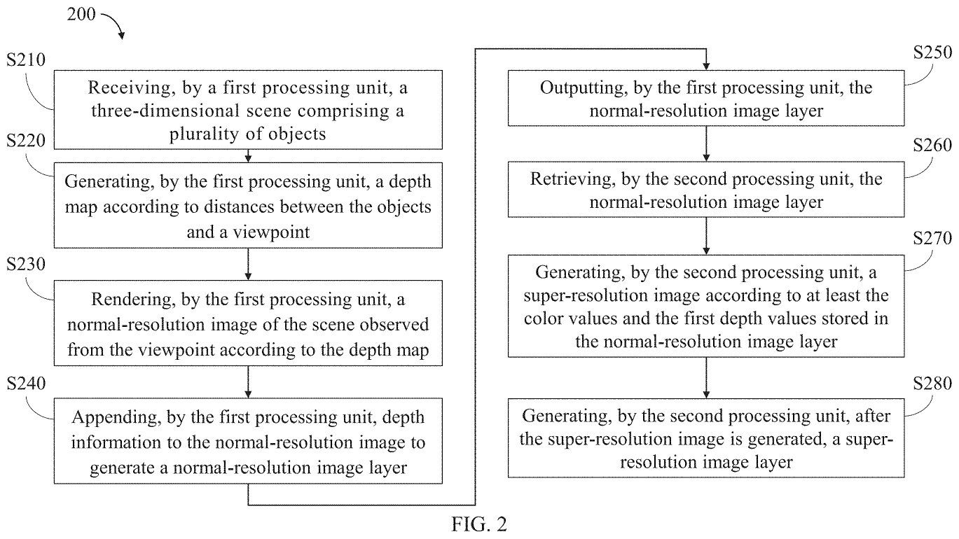

FIG. 2 shows a flowchart of a method 200 for generating super-resolution images according to one embodiment of the present disclosure. In the present embodiment, the method 200 includes steps S210 to S280, and the method 200 can be performed with the image processing system 100.

For example, in step S210, the first processing unit 110 can receive a three-dimensional scene. In some embodiments, the three-dimension scene may be, for example, a scene of a PC game or a video game and may be built by a game designer.

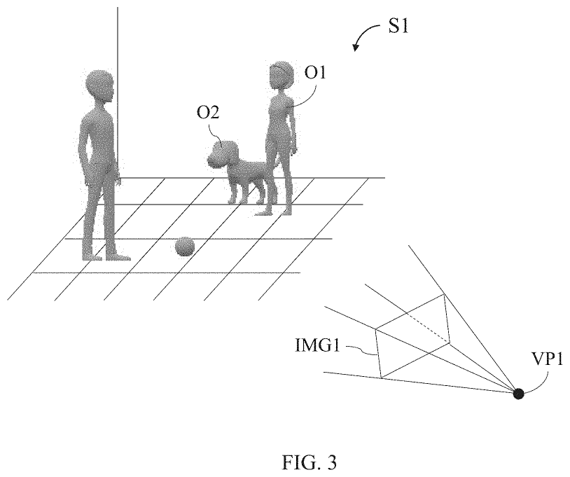

FIG. 3 shows a three-dimensional scene Si according to one embodiment of the present disclosure. As shown in FIG. 3, the scene S1 may include a plurality of objects. In some embodiments, in step S220. the first processing unit 110 may generate a depth map according to distances between the objects and a viewpoint VP1. With the depth information provided by the depth map, the first processing unit 110 is able to distinguish an object at the front from an object at the back if the two objects are overlapping when observed from the viewpoint VP1. For example, if the distance between an object O1 and the viewpoint VP1 is less than the distance between an object O2 and the viewpoint VP1, then the object O1 should be in front of the object O2, and the object O1 may partly occlude the farther object O2 in the image IMG1 when observing the scene S1 from the viewpoint VP1.

As a result, according to the depth map generated in step S220, the first processing unit 110 may render the image IMG1 of the scene Si observed from the viewpoint VP1 in step S230. After the normal-resolution image IMG1 is generated, the first processing unit 110 may further append the depth information to the normal-resolution image IMG1 to generate the normal-resolution image layer LY1 in step S240. Next, the first processing unit 110 may output the normal-resolution image layer LY1 in step S250.

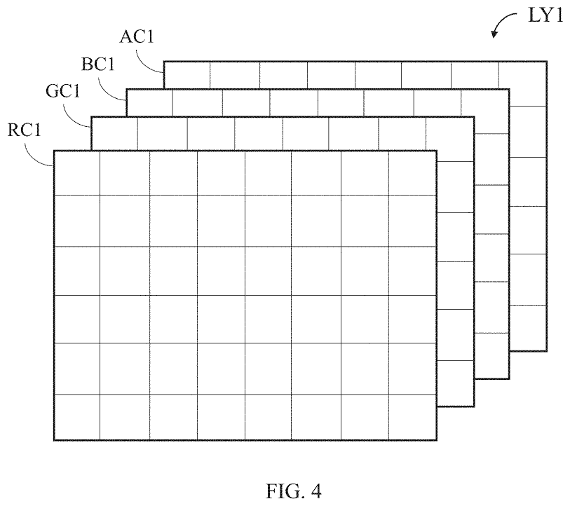

FIG. 4 shows the normal-resolution image layer LY1 according to one embodiment of the present disclosure. As shown in FIG. 4, the normal-resolution image layer LY1 may include three color channels RC1, GC1 and BC1 plus one alpha channel AC1. In computer graphics, an alpha channel is often used to store numeric values representative of a level of transparency of each pixel, and thus the alpha channel is often included in an image layer along with color channels. However, it is noted that the image layers are opaque in most applications so the numeric values stored in the alpha channel may all be the same. For example, if each numeric value of the alpha channel is represented by 8 bits, then all pixels in the alpha channel may have the same value of 255 indicating that all of the pixels are fully opaque. In such case, saving the same values to the alpha channel of an image layer seems to be a waste of memory.

Therefore, in the present embodiment, while color values, such as red, green, and blue intensities, of each pixel of the normal-resolution image IMG1 are stored in the color channels RC1, GC1 and BC1 of the normal-resolution image layer LY1, depth values, instead of the transparency information, are stored in the alpha channel AC1 of the normal-resolution image layer LY1 on a per-pixel basis. Consequently, the image layer LY1 is able to carry the depth information generated by the first processing unit 110 without the creation of additional files or consumption of extra storage space. Although the second processing unit 120 may be a display processing unit outside of the GPU (the first processing unit 110), it can still access the intra-GPU metadata such as the depth information generated by the GPU during rendering through the alpha channel AC1 of the image layer LY1. In this way, the second processing unit 120 can generate a better quality of the super-resolution image with the aid of intra-GPU metadata including the depth information.

However, in some other embodiments, other types of metadata may be adopted and stored in the alpha channel AC1. For example, in some embodiments, stencil values generated during the image rendering process and stored in a stencil map of the first processing unit 110 may be selected and stored in the alpha channel to AC1 of the image layer LY1. In such case, the second processing unit 120 may generate the super-resolution image IMG2 according to the color values and the stencil values stored in the image layer LY1. Alternatively, the first processing unit 110 may still store the depth values in the alpha channel AC1 of the image layer LY1 and additionally create a metadata file corresponding to the normal-resolution image IMG1 for storing the selected types of information, such as the stencil map, and store the metadata file in the memory 130. In such case, the first processing unit 110 and the second processing unit 120 may require more time and memory space to write the image layer LY1 and the metadata file to the memory 130 and read the image layer LY1 and the metadata file from the memory 130. The additional information stored in the metadata file indeed allows the second processing unit 120 to further improve the quality of the super-resolution image IMG2.

In some embodiments, the depth map generated in step S220 may have the same spatial size as the image IMG1, that is, the depth map may comprise a plurality of depth values, each of which corresponds to a pixel of the image IMG1. Since the depth values are used to determine whether a whole or part of object should be seen from the viewpoint VP1 when there are multiple overlapping objects, the depth values can be crucial for the rendering process of the image IMG1. Therefore, in some embodiments, the depth value of each pixel stored in the depth map may need more bits to achieve better depth-of-field rendering. For example, the pixel format of a depth value stored in the depth map may be 16 bits, 24 bits, or 32 bits per pixel, that is, each depth value may occupy two, three, or four bytes.

However, the alpha channel AC1 of the image layer LY1 may be designed to store alpha values with a pixel format of 8 bits. In such case, without changing the size of the alpha channel AC1, the first processing unit 110 may transform depth values from a pixel format having a longer bit length into 8-bit per pixel instead so as to store the depth values in the alpha channel AC1. The transformation should ensure the positive correlation between the original depth values and the after-transformation values stored in the alpha channel AC1.

In step S260, after the normal-resolution image layer LY1 is generated and outputted, the second processing unit 120 may retrieve the normal-resolution to image layer LY1. In the present embodiment, the memory 130 may be the GPU output buffer of the first processing unit 110, so the first processing unit 110 may output and store the normal-resolution image layer LY1 in the memory 130, and the second processing unit 120 may access the memory 130 to retrieve the normal-resolution image layer LY1 including the alpha channel AC1 that carries depth information.

In step S270, the second processing unit 120 may generate a super-resolution image IMG2 according to at least the color values and the depth values stored in the normal-resolution image layer LY1. In some embodiments, the second processing unit 120 may include a neuro-network model 122 for generating the super-resolution image IMG2. In some embodiments, the neuro-network model 122 can be realized by a multi-core processor or a single-core processor running a software program of a desired algorithm.

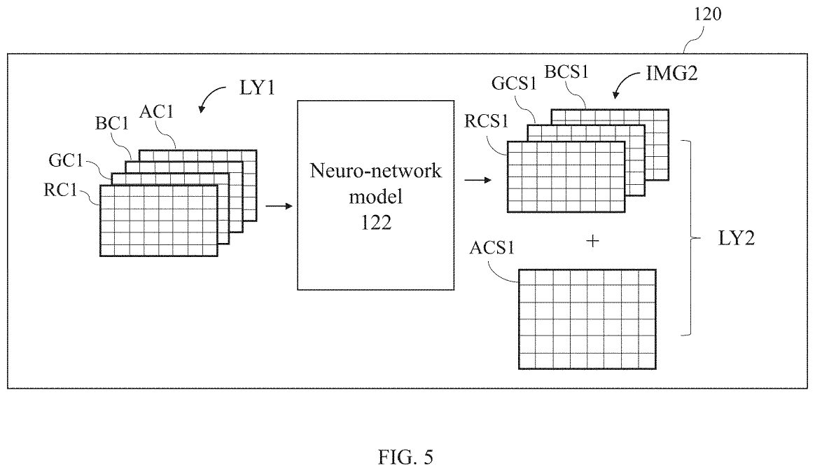

In step S280, after the super-resolution image IMG2 is generated, the second processing unit 120 may further generate a super-resolution image layer LY2 for the purpose of display. FIG. 5 shows an illustrative diagram of the second processing unit 120 that generates the super-resolution image IMG2 and the super-resolution image layer LY2.

As shown in FIG. 5, the normal-resolution image layer LY1 comprising the color channels RC1, GC1 and BC1 plus the alpha channel AC1 can be retrieved and fed to the neuro-network model 122. In the present embodiment, the neuro-network model 122 may generate the super-resolution image IMG2 according to the color values and the depth values stored in the image layer LY1 by using a deep learning algorithm.

Furthermore, in some embodiments, the second processing unit 120 may be a display processing unit that can be used to prepare a final image to be displayed by a display panel. For example, the second processing unit 120 may adjust the color values of the super-resolution image IMG2 according to characteristics of the display panel before the super-resolution image IMG2 is displayed by the display panel so that the image shown on the display panel can be in a better condition, for example, in terms of white balance. Furthermore, it may be necessary to combine one image with another to create a single, final image for display. In such case, the second processing unit 120 may receive multiple image layers and may blend the color components of the pixels in those image layers according to the alpha values stored in the alpha channels of those image layers.

However, since the alpha values of the normal-resolution image IMG1 have been replaced by the depth values in the previous process, the second processing unit 120 may need to append alpha values to the super-resolution image IMG2 for generating the super-resolution image layer so that the second processing unit 120, such as the DPU, may blend the super-resolution image layer LY2 and other image layers into the final image for display.

As shown in FIG. 5, the super-resolution image layer LY2 includes three color channels RCS1, GCS1 and BCS1 along with one alpha channel ACS1. In the present embodiment, color values of each pixel of the super-resolution image IMG2 are stored in the three color channels RCS1, GCS1 and BCS1 of the super-resolution image layer LY2 while alpha values are stored in the alpha channel ACS1 of the super-resolution image layer LY2 on a per-pixel basis. Furthermore, in the present embodiment, since the alpha values are replaced by the depth value in the alpha channel AC1 of the normal-resolution image layer LY1, the second processing unit 120 may auto-fill the alpha channel ACS1 of the super-resolution layer LY2 with a predetermined value, for example, 255. The alpha channel ACS1 and the color channels RCS1, GCS1, BCS1 are of the same size. Consequently, the super-resolution image layer LY2 can be used as a regular image layer and can be blended with other image layers for display.

In summary, the image processing system and the method for generating super-resolution images provided by the embodiments of the present disclosure can use a first processing unit to render a normal-resolution image and append depth information generated during the image rendering process to the normal-resolution image layer of the normal-resolution image, and use a second processing unit to generate a super-resolution image according to both the color values and the depth values of the normal-resolution image. Since the second processing unit can generate the super-resolution image according to different types of information, the neuro-network model adopted by the second processing unit can be trained better and the quality of the super-resolution image can be improved. Furthermore, since the depth values are appended to the image layer in the alpha channel, no extra data transfer is required, thereby improving the hardware efficiency of the system.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. An image processing system, comprising:
first processing unit configured to receive a three-dimensional scene comprising a plurality of objects, generate a depth map according to distances between the objects and a viewpoint, render a normal-resolution image of the scene observed from the viewpoint according to the depth map, append depth information to the normal-resolution image to generate a normal-resolution image layer, and output the normal-resolution image layer, wherein the normal-resolution image layer comprises three color channels and one alpha channel, color values of each of a plurality of pixels of the normal-resolution image are stored in the three color channels of the normal-resolution image layer, and first depth values of the pixels of the normal-resolution image are stored in the alpha channel of the normal-resolution image layer; and
a memory configured to store the normal-resolution image layer.

2. The image processing system of claim 1, wherein the first processing unit is a graphics processing unit (GPU).

3. The image processing system of claim 1, further comprising a second processing unit configured to retrieve the normal-resolution image layer from the memory, and to generate a super-resolution image according to at least the color values and the first depth values stored in the normal-resolution image layer.

4. The image processing system of claim 3, wherein after the super-resolution image is generated, the second processing unit is further configured to generate a super-resolution image layer comprising three color channels and one alpha channel, wherein the second processing unit stores color values of each of a plurality of pixels of the super-resolution image in the three color channels of the super-resolution image layer, and stores identical alpha values for the pixels of the super-resolution image in the alpha channel of the super-resolution image layer.

5. The image processing system of claim 3, wherein the second processing unit is a display processing unit (DPU) and is further configured to adjust the color values of the super-resolution image according to characteristics of a display panel before the super-resolution image is displayed by the display panel.

6. The image processing system of claim 3, wherein the second processing unit is configured to generate the super-resolution image according to a neuro-network model by using the color values and the first depth values stored in the normal-resolution image layer as input data.

7. The image processing system of claim 3, wherein the first processing unit is further configured to generate a metadata file corresponding to the normal-resolution image and store the metadata file in the memory, and the second processing unit is further configured to generate the super-resolution image according to the color values and the first depth values stored in the normal-resolution image layer along with the metadata file.

8. The image processing system of claim 7, wherein the metadata file is a stencil map corresponding to the normal-resolution image.

9. The image processing system of claim 1, wherein:
the depth map comprises a plurality of second depth values of the objects with respect to the viewpoint;
the first processing unit is further configured to transform the second depth values into the first depth values so that a bit length of each of the first depth values is shorter than a bit length of each of the second depth values; and
there is positive correlation between the first depth values and the second depth values.

10. The image processing system of claim 9, wherein the bit length of each of the first depth values is 8 bits.

11. An image processing system, comprising:
a first processing unit configured to receive a three-dimensional scene comprising a plurality of objects, generate depth information of the objects in the three-dimensional scene from a viewpoint, render a normal-resolution image of the scene observed from the viewpoint according to the depth information, append the depth information to the normal-resolution image to generate a normal-resolution image layer, and output the normal-resolution image layer, wherein the normal-resolution image layer comprises three color channels and one alpha channel, color values of each of a plurality of pixels of the normal-resolution image are stored in the three color channels of the normal-resolution image layer, and first depth values representing the depth information for each of the pixels of the normal-resolution image are stored in the alpha channel of the normal-resolution image layer; and
a second processing unit configured to retrieve the normal-resolution image layer, and to generate a super-resolution image according to at least the color values and the first depth values stored in the normal-resolution image layer.

12. The image processing system of claim 11, wherein after the super-resolution image is generated, the second processing unit is further configured to generate a super-resolution image layer comprising three color channels and one alpha channel, wherein the second processing unit stores color values of each of a plurality of pixels of the super-resolution image in the three color channels of the super-resolution image layer, and stores identical alpha values for the pixels of the super-resolution image in the alpha channel of the super-resolution image layer.

13. The image processing system of claim 11, wherein the first processing unit is a graphics processing unit (GPU), the second processing unit is a display processing unit (DPU), and the second processing unit is further configured to adjust the color values of the super-resolution image according to characteristics of a display panel before the super-resolution image is displayed by the display panel.

14. The image processing system of claim 11, wherein the second processing unit is configured to generate the super-resolution image according to a neuro-network model by using the color values and the first depth values stored in the normal-resolution image layer as input data.

15. The image processing system of claim 11, wherein:
the depth information comprises a plurality of second depth values of the objects with respect to the viewpoint;
the first processing unit is further configured to transform the second depth values into the first depth values so that a bit length of each of the first depth values is shorter than a bit length of each of the second depth values; and
there is positive correlation between the first depth values and the second depth values.

16. The image processing system of claim 15, wherein:
the bit length of each of the first depth values is 8 bits.

17. A method for generating a super-resolution image, comprising:
receiving, by a first processing unit, a three-dimensional scene comprising a plurality of objects;
generating, by the first processing unit, a depth map according to distances between the objects and a viewpoint;
rendering, by the first processing unit, a normal-resolution image of the scene observed from the viewpoint according to the depth map;
appending, by the first processing unit, depth information to the normal-resolution image to generate a normal-resolution image layer;
outputting, by the first processing unit, the normal-resolution image layer, wherein the normal-resolution image layer comprises three color channels and one alpha channel, color values of each of a plurality of pixels of the normal-resolution image are stored in the three color channels of the normal-resolution image layer, and first depth values of the pixels of the normal-resolution image are stored in the alpha channel of the normal-resolution image layer;
retrieving, by a second processing unit, the normal-resolution image layer; and
generating, by the second processing unit, a super-resolution image according to at least the color values and the first depth values stored in the normal-resolution image layer.

18. The method of claim 17, further comprising:
generating, by the second processing unit, after the super-resolution image is generated, a super-resolution image layer comprising three color channels and one alpha channel;
wherein color values of each of a plurality of pixels of the super-resolution image are stored in the three color channels of the super-resolution image layer, and alpha values, which are the same, for the plurality of pixels of the super-resolution image are stored in the alpha channel of the super-resolution image layer.

19. The method of claim 17, wherein the act of generating the super-resolution image by the second processing unit comprises generating the super-resolution image according to a neuro-network model by using the color values and the first depth values stored in the normal-resolution image layer as input data.

20. The method of claim 17, wherein:
the depth map comprises a plurality of second depth values of the objects with respect to the viewpoint;
the method further comprises transforming, by the first processing unit, the second depth values into the first depth values so that a bit length of each of the first depth values is shorter than a bit length of each of the second depth values; and
there is positive correlation between the first depth values and the second depth values.
